(19) United States
(12) Patent Application Publication
(10) Pub. No.: US 2026/0121311 A1
(43) Pub. Date: Apr. 30, 2026

(54) RF PLUG CONNECTOR, RF RECEPTACLE CONNECTOR, AND RF CONNECTOR

(71) Applicant: SENSORVIEW CO., LTD., Seongnam-si (KR)

(72) Inventors: Byoung Nam KIM, Suwon-si (KR); Hong Il YOO, Gwangmyeong-si (KR); Sung Cheol CHO, Incheon (KR); Du Ho KANG, Suwon-si (KR); Jae Kun CHOI, Suwon-si (KR)

(73) Assignee: SENSORVIEW CO., LTD., Seongnam-si (KR)

(21) Appl. No.: 18/929,997

(22) Filed: Oct. 29, 2024

(51) Int. Cl. H01R 9/22; H01R 9/16; H01R 9/24

(52) U.S. Cl. CPC H01R 9/223; H01R 9/16; H01R 9/2491; H01R 2201/24

(57) ABSTRACT

The present invention may provide a radio frequency (RF) plug connector in which a plurality of plug partitions are arranged in rows and columns, the RF plug connector including: a plug shield wall configured to form the plug partitions in a grid shape; a plug body arranged within the plug partition; a plug pin coupled to the plug body; and a plug shell coupled to the plug shield wall, wherein the plug shield wall comprises a plurality of first longitudinal walls arranged with the plug pin positioned therebetween, and a plurality of first transverse walls intersecting with the first longitudinal walls, with the plug pin positioned therebetween.

### TECHNICAL FIELD

The following description generally relates to a radio frequency (RF) plug connector, an RF receptacle connector, and an RF connector, and more particularly, to an RF connector with electromagnetic interference (EMI) suppression functionality for high-frequency use.

### BACKGROUND ART

Various types of electronic devices have electrical circuits implemented on circuit boards. Electronic devices include a plurality of circuit boards, which can be electrically connected to each other. Connectors may be used to electrically connect the electronic components and circuit boards that constitute the electronic device.

A connector may consist of a plug connector and a receptacle connector. The receptacle connector is mounted on a circuit board, and the plug connector is coupled to a cable. The plug connector is fastened to the receptacle connector, allowing the cable and the circuit board, or the circuit boards, to be electrically connected to each other.

Such a connector assembly is also widely used in ultra-high-speed wireless communication devices, such as 5G devices, and excellent electromagnetic wave shielding performance is required as the frequency increases. However, conventional radio frequency (RF) connectors do not exhibit electromagnetic wave shielding performance as required at high frequencies, and there is a particular issue with vulnerability to electromagnetic interference between cables and between signal pins within the connector when the multiple cables are simultaneously connected to a circuit board through a single connector.

As a technology related to the present invention, a connector and a connector device disclosed in the Korean Laid-Open Patent Publication include a plug shield and a receptacle shield but lack a means to shield between multiple plug pins or between multiple receptacle pins. The present invention is distinguished from the prior art by having a structure that provides shielding between multiple terminals, thereby differentiating the configuration and effects of the two inventions.

### PRIOR ART DOCUMENT

Korean Laid-Open Patent Publication No. 10-2021-0045307 (published on Apr. 26, 2021)

### DISCLOSURE

### Technical Problem

An objective of the present invention is to provide a radio frequency (RF) connector with electromagnetic interference (EMI) suppression functionality.

The objective to be achieved by the present invention is not limited to the foregoing, and additional objectives, which are not mentioned herein, will be readily understood by those skilled in the art from the following description.

### Technical Solution

An embodiment provides an RF plug connector in which a plurality of plug partitions are arranged in rows and columns, the RF plug connector including: a plug shield wall configured to form the plug partitions in a grid shape; a plug body arranged within the plug partition; a plug pin coupled to the plug body; and a plug shell coupled to the plug shield wall, wherein the plug shield wall comprises a plurality of first longitudinal walls arranged with the plug pin positioned therebetween, and a plurality of first transverse walls intersecting with the first longitudinal walls, with the plug pin positioned therebetween.

The first longitudinal wall may be arranged to intersect with at least two of the first transverse walls, and one of the first transverse walls may be arranged to intersect with at least two of the first longitudinal walls.

Two of the first longitudinal walls may be arranged opposite each other with the plug pin positioned therebetween, two of the first transverse walls may be arranged opposite other with the plug pin positioned therebetween, and the first longitudinal walls and the first transverse walls may be connected to each other to surround the plug pin.

The plug shield wall may include first protrusions protruding from respective inner walls of the first longitudinal walls and the first transverse walls, the plug body may include a first groove concavely formed on a side surface thereof, and the first protrusion may be arranged in the first groove.

The plug shield wall may include a second protrusion and a third protrusion protruding from an outer surface thereof, and the plug shell may include a second groove in which the second protrusion is arranged and a third groove in which the third protrusion is arranged.

In the vertical direction, the position of the first protrusion may differ from the position of the second protrusion, the second groove may be concavely formed on an upper end of the plug shell, and the third groove may be concavely formed on a lower end of the plug shell.

The plug shield wall may include a body made of a resin material, and a metal layer coated on the body.

The plug pin may include a first part coupled to the plug body, and a second part that is bent from the first part and include a first contact surface, and the first contact surface may be formed as a flat surface.

An embodiment may provide an RF receptacle connector in which a plurality of receptacle partitions are arranged in rows and columns, the RF receptacle connector including: a receptacle shield wall configured to form the receptacle partitions in a grid shape; a receptacle body arranged within the receptacle partition; a receptacle pin coupled to the receptacle body; and a receptacle shell coupled to the receptacle shielding wall, wherein the receptacle shield wall comprises a plurality of second longitudinal walls arranged with the plug pin positioned therebetween, and a plurality of second transverse walls intersecting with the second longitudinal walls, with the plug pin positioned therebetween.

The second longitudinal wall may be arranged to intersect with at least two of the second transverse walls, and one of the second transverse walls may be arranged to intersect with at least two of the second longitudinal walls.

Two of the second longitudinal walls may be arranged opposite each other with the receptacle pin placed therebetween, two of the second transverse walls may be arranged opposite each other with the receptacle pin placed therebetween, and the second longitudinal walls and the second transverse walls may be connected to each other to surround the receptacle pin.

The receptacle body may include a second groove concavely formed on a side surface thereof, and a portion of the receptacle body may be positioned in the second groove.

The receptacle shield wall may include a fourth protrusion protruding from the outer surface thereof, and the receptacle shell may include a hole in which the fourth protrusion is arranged.

The hole may be arranged on the lower end of the receptacle shell and pass through the inside and outside of the receptacle shell. The receptacle shield wall may be made of a metallic material.

The receptacle pin may include a third part coupled to the receptacle body and a fourth part that is bent from the third part and includes a second contact surface, and the second contact surface may be formed as a curved surface.

An embodiment may provide an RF connector including an RF plug connector in which a plurality of plug partitions are arranged in rows and columns, and an RF receptacle connector in which a plurality of receptacle partitions are arranged in rows and columns, wherein the RF plug connector comprises a plug shield wall configured to form a grid surrounding a plug pin, the RF receptacle connector comprises a receptacle shield wall configured to form a grid surrounding a receptacle pin, and the plug shielding wall is stacked on the receptacle shield wall.

The plug shield wall may include a plurality of first longitudinal walls arranged with the plug pin positioned therebetween and a plurality of first transverse walls intersecting with the first longitudinal walls, with the plug pin positioned therebetween, and the receptacle shield wall may include a plurality of second longitudinal walls arranged with the plug pin positioned therebetween, and a plurality of second transverse walls intersecting with the second longitudinal walls, with the plug pin positioned therebetween.

In the vertical direction, the thickness of the plug shield wall may be greater than the thickness of the receptacle shield wall.

A lower surface of the plug shield wall may be in contact with an upper surface of the receptacle shield wall.

The contact area between the plug shield wall and the receptacle shield wall may be positioned lower than the contact area between the plug pin and the receptacle pin in the vertical direction.

The details of other embodiments are incorporated in “Detailed Description” and accompanying “Drawings”.

The advantages and/or features, and schemes of achieving the advantages and features of the present invention will be apparently comprehended by those skilled in the art based on the embodiments, which are detailed later in detail, together with accompanying drawings.

However, the present invention is not limited to the following embodiments but includes various applications and modifications. The embodiments will make the disclosure of the present invention complete, and allow those skilled in the art to completely comprehend the scope of the present invention. The present invention is only defined within the scope of accompanying claims.

### Advantageous Effects

According to the present invention, a plurality of RF input/output terminals for high frequency can be arranged in rows and columns.

Also, the space between the plurality of plug pins and receptacle pins arranged in rows and columns can be shielded.

Effects that can be achieved by the connector for high frequency use according to the technical idea of the present invention are not limited to the foregoing effects, and additional effects, which are not mentioned herein, will be readily understood by those skilled in the art from the following description.

### DESCRIPTION OF DRAWINGS

FIG. 1 is a view illustrating an example of a radio frequency (RF) connector according to one embodiment of the present invention.

FIG. 2 is a view illustrating an RF plug connector and an RF receptacle connector of the RF connector shown in FIG. 1.

FIG. 3 is a view illustrating an RF plug connector.

FIG. 4 is a view illustrating a plug pin.

FIG. 5 is a view illustrating a plug body.

FIG. 6 is a perspective view of a plug shell.

FIG. 7 is a perspective view illustrating a plug shield wall.

FIG. 8 is a plan view of the plug shield wall illustrated in FIG. 7.

FIG. 9 is a view illustrating an RF receptacle connector.

FIG. 10 is a view illustrating a receptacle pin.

FIG. 11 is a view illustrating a receptacle body.

FIG. 12 is a perspective view of a receptacle shell.

FIG. 13 is a view illustrating a receptacle shield wall.

FIG. 14 is a cross-sectional side view of the RF connector, taken along line A-A of FIG. 1.

FIG. 15 is a view illustrating a contact state of the plug pin and the receptacle pin.

FIG. 16 is a view illustrating the process of assembling the plug body and the receptacle body.

FIG. 17 is a cross-sectional side view of the RF connector, taken along line B-B of FIG. 1.

### DETAILED DESCRIPTION

Before describing the present invention in detail, terms and words used herein should not be construed as being unconditionally limited in a conventional or dictionary sense, and the inventor of the present invention can define and use concepts of various terms appropriately as needed in order to explain the present invention in the best way. Furthermore, it should be understood that these terms and words are to be construed in light of the meanings and concepts consistent with the technical idea of the present invention.

In other words, the terminology used herein is for the purpose of describing exemplary embodiments of the present invention, and is not intended to specifically limit the content of the present invention. It should be understood that these terms are defined terms in view of the various possibilities of the present invention.

Further, in this specification, the singular forms “a,” “an,” and “the” include plural referents unless the context clearly dictates otherwise. Also, it should be understood that the present invention can include a singular meaning even if it is similarly expressed in plural.

Where a component is referred to as “comprising” another component throughout this specification, unless specified otherwise, this means the component does not exclude any other element but may further include any other element.

Furthermore, when it is stated that an element is “inside or connected to another element,” this element may be directly connected to another element or may be installed in contact with it. In addition, it may be installed spaced apart with a predetermined distance, and in the case where a component is installed to be spaced apart with a predetermined distance, a third component or means for fixing or connecting the component to another component may be present. Also, it should be noted that the description of the third component or means may be omitted.

On the other hand, it should be understood that there is no third component or means when an element is described as being “directly coupled” or “directly connected” to another element.

Likewise, other expressions that describe the relationship between the components, such as “between” and “right between,” or “neighboring to” and “directly adjacent to” and such should be understood in the same spirit.

Further, in this specification, when terms such as “one surface,” “other surface,” “one side,” “other side,” “first,” “second” and such are used, it is to clearly distinguish one component from another. It should be understood, however that the meaning of the component is not limited by such term.

It is also to be understood that terms related to positions such as “top,” “bottom,” “left,” “right,” and the like in this specification are used to indicate relative positions in the drawings for the respective components. Further, unless an absolute position is specified for these positions, it should not be understood that these position-related terms refer to absolute positions.

In addition, in this specification, the same reference numerals are used for the respective constituent elements of the drawings, and the same constituent elements are denoted by the same reference numerals even if they are shown in different drawings, that is, the same reference numerals indicate the same components throughout this specification.

It is to be understood that the size, position, coupling relationships and such, of each component constituting the present invention in the accompanying drawings, may be partially exaggerated or reduced or omitted to be able to sufficiently clearly convey the scope of the invention or for convenience of describing, and therefore the proportion or scale thereof may not be rigorous.

Also, in the following description of the present invention, a detailed description of a configuration that is considered to unnecessarily obscure the gist of the present invention, for example, a known technology including the prior art, may be omitted.

Hereinafter, embodiments of the present invention will be described in detail with reference to the accompanying drawings.

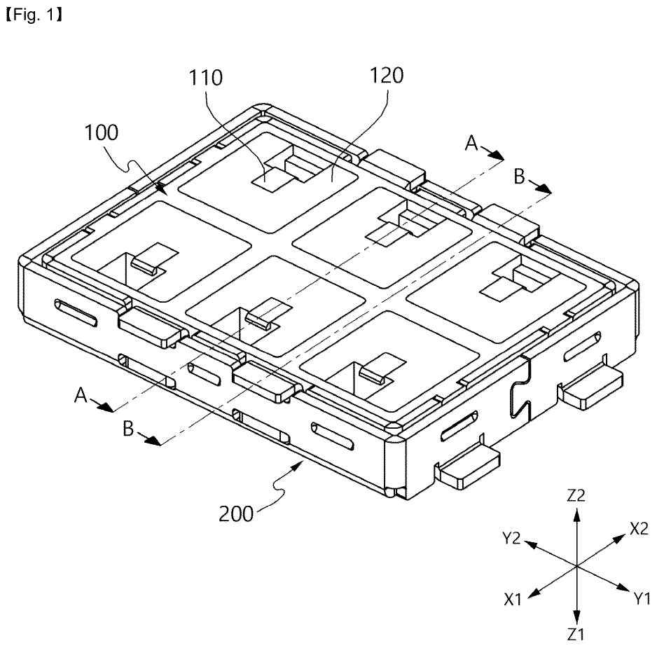

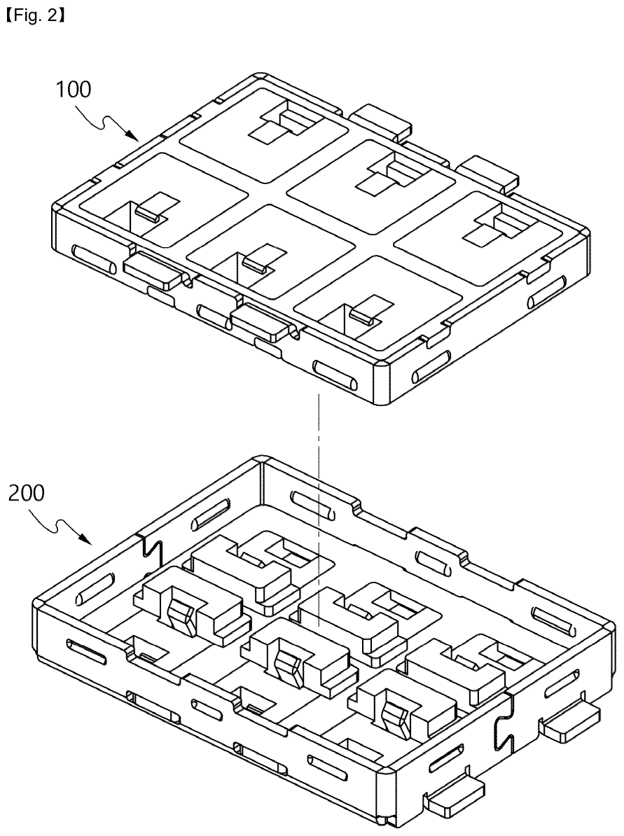

FIG. 1 is a view illustrating an example of a radio frequency (RF) connector according to one embodiment of the present invention, and FIG. 2 is a view illustrating an RF plug connector 100 and an RF receptacle connector 200 of the RF connector shown in FIG. 1.

Referring to FIGS. 1 and 2, the RF connector according to one embodiment of the present invention is depicted in a three-dimensional space represented by three axes: a horizontal direction (X1 to X2), a vertical direction (Y1 to Y2), and a perpendicular direction (Z1 to Z2). A plurality of partitions are arranged in rows and columns in the RF connector.

The RF connector may include an RF plug connector 100 and an RF receptacle connector 200. The RF plug connector 100 corresponds to a male connector, while the RF receptacle connector 200 corresponds to a female connector. Therefore, the RF plug connector 100 and the RF receptacle connector 200 can be mechanically and electrically fastened to and separated from each other.

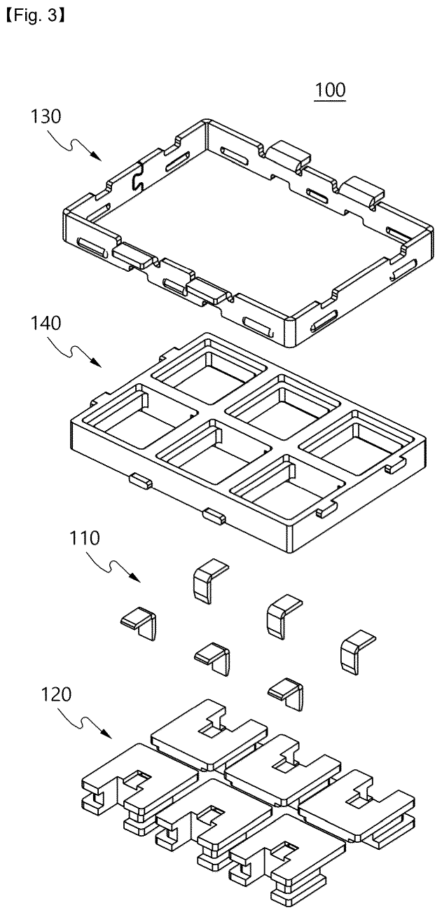

FIG. 3 is a view illustrating the RF plug connector 100.

Referring to FIG. 3, the RF plug connector 100 may include a plug pin 110, a plug body 120, a plug shell 130, and a plug shield wall 140.

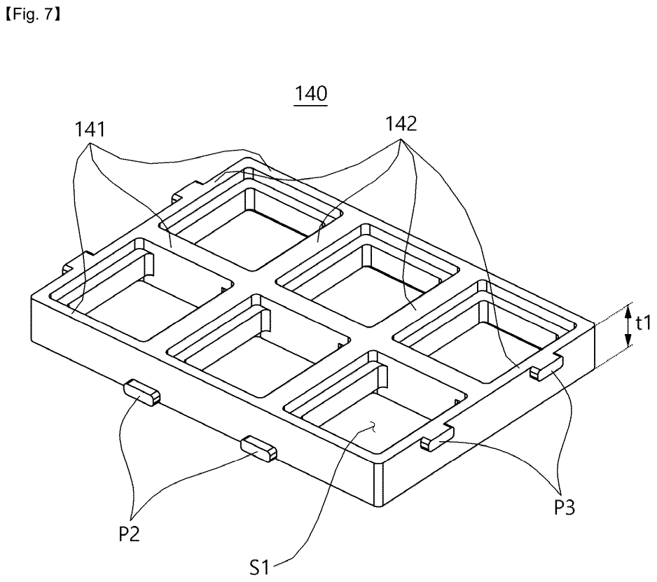

The plug shield wall 140 is positioned inside the plug shell 130. The plug body 120 is positioned inside the plug shield wall 140. The plug shield wall 140 forms a plurality of partitions (S1 in FIG. 7), and a plug pin 110 is placed in each partition. For example, the plug body 120 may form six partitions S1, and six plug pins 110 may be placed, one in each partition S1.

The plug body 120 may be molded through double injection with the plug shield wall 140 and the plug pin 110 in place. Accordingly, in the molding process of the plug body 120, the plug shield wall 140 and the plug pin 110 may be formed to be coupled to the plug body 120.

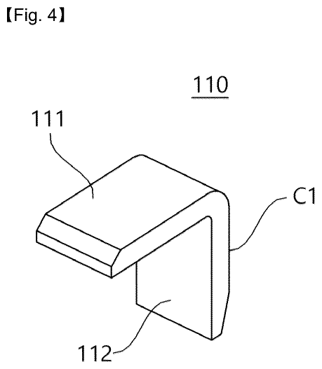

FIG. 4 is a view illustrating the plug pin 110.

Referring to FIG. 4, the plug pin 110 makes electrical contact with a receptacle pin 210. The plug pin 110 may be divided into a first part 111 and a second part 112. The first part 111 is a horizontal component of the plug pin 110, and the second part 112 is a vertical component of the plug pin 110, both of which include surfaces that are coupled to the plug body 120. The second part 112 may be bent from the first part 111 and include a first contact surface C1 that makes contact with the receptacle pin 210.

Referring back to FIG. 2, during the process in which the first contact surface C1 of the plug pin 110 makes contact with the receptacle pin 210, the plug pin 110 may be subjected to force in the directions Z2 and X1. To prevent the plug pin 110 from dislodging from the plug body 120, the inner surface of the second part 112 may be in contact with and supported by the plug body 120, and at least part of the outer surface of the first part 111 may be in contact with and supported by the plug body 120. Particularly, the bent portion, which receives the most force, may be formed inside the plug body 120.

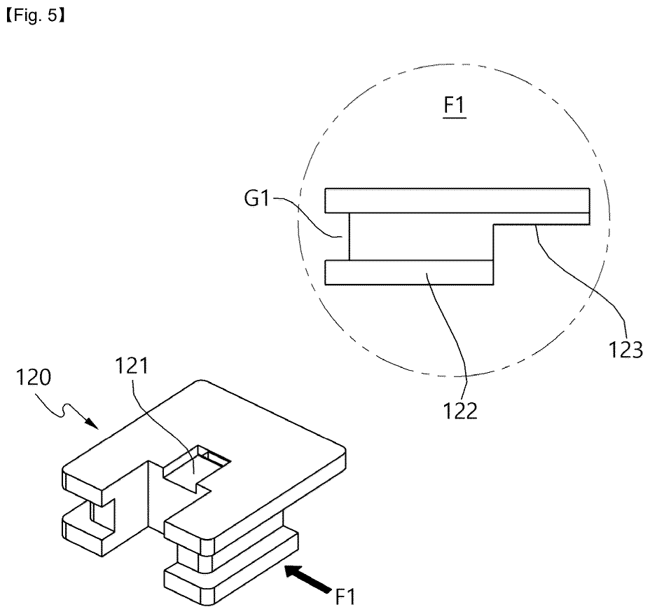

FIG. 5 is a view illustrating the plug body 120.

Referring to FIG. 5, the plug body 120 may include a first seating portion 121 on its upper surface, where the plug pin 110 is seated. Additionally, the plug body 120 may include a first groove G1 concavely formed on its side surface. The first groove G1 may be positioned along the periphery of the plug body 120. The first groove G1 is the part where the plug shield wall 140 is inserted.

Meanwhile, the plug body 120 may include a first convex portion 122 and a first concave portion 123.

The first convex portion 122 is a portion of the plug body 120 that protrudes relatively downwards, and the first concave portion 123 is a portion of the plug body 120 that is recessed relative to the first convex portion 122. The first convex portion 122 and the first concave portion 123 are for assembly with the receptacle body 220.

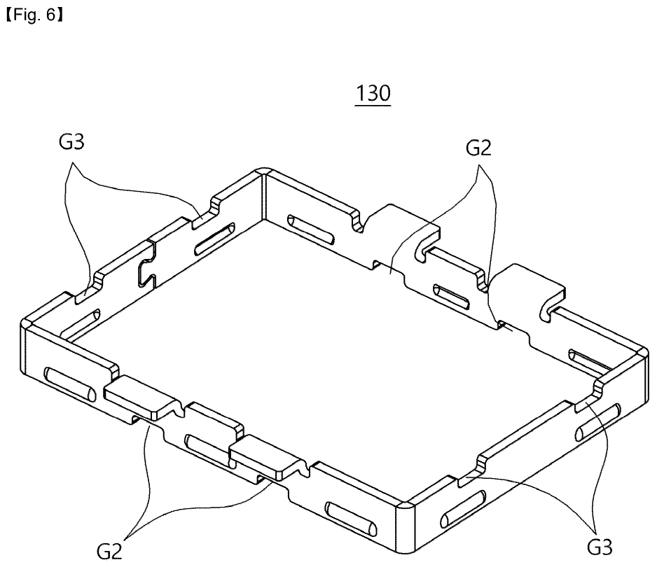

FIG. 6 is a perspective view of the plug shell 130.

Referring to FIG. 6, the plug shell 130 may be manufactured separately from the plug body 120, the plug pin 110, and the plug shield wall 140. The plug shell 130 may have a rectangular frame shape formed by a combination of longitudinal and transverse walls. The plug shell 130 may include a second groove G2 and a third groove G3. The second groove G2 may be formed concavely on the lower surface of each longitudinal wall of the plug shell 130. A plurality of second grooves G2 may be arranged. The third groove G3 may be formed concavely on the lower surface of each transverse wall of the plug shell 130. These first groove G1 and second groove G2 are provided for coupling with the plug shield wall 140.

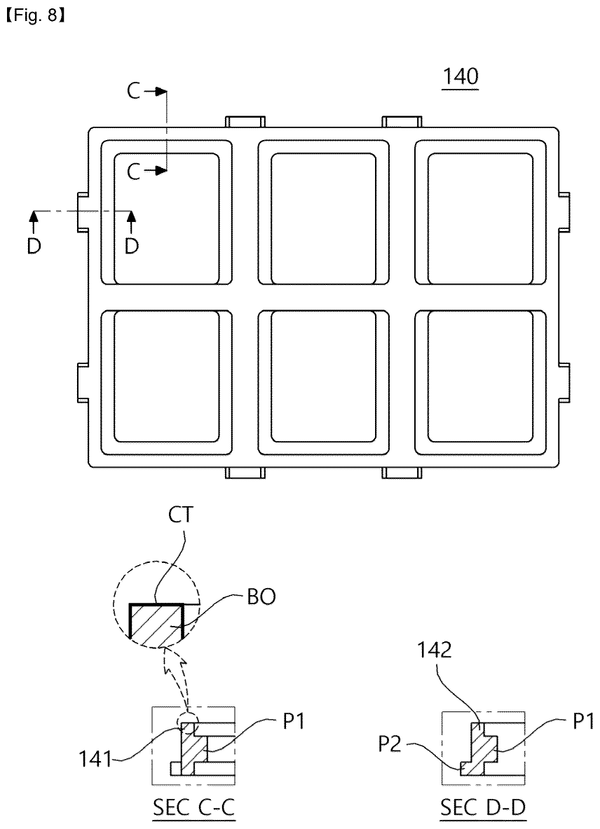

FIG. 7 is a perspective view illustrating the plug shield wall 140, and FIG. 8 is a plan view of the plug shield wall 140 illustrated in FIG. 7.

Referring to FIGS. 7 and 8, the plug shield wall 140 may include a plurality of first longitudinal walls 141 and a plurality of first transverse walls 142. The plurality of first longitudinal walls 141 may be arranged at regular intervals. The plurality of first transverse walls 142 may also be arranged at regular intervals.

Each of the first longitudinal walls 141 is arranged to intersect with at least two of the first transverse walls 142. Likewise, each of the first transverse walls 142 is arranged to intersect with at least two of the first longitudinal walls 141. These first longitudinal walls 141 and first transverse walls 142 are arranged to form a grid structure, creating enclosed partitions S1 inside. The plug pin 110 is positioned in each partition S1. The first longitudinal walls 141 and first transverse walls 142 may have the same thickness. The upper ends of the first longitudinal walls 141 and the upper ends of the first transverse walls 142 may be positioned on the same plane.

The plug shield wall 140 forms the partitions S1, each of which surrounds a plug pin 110 inside, thereby shielding the electromagnetic interference (EMI) generated by the plug pins 110. Specifically, when viewed from the vertical direction, the first longitudinal walls 141 and the first transverse walls 142 are arranged to completely surround the plug pin 110, effectively shielding the EMI generated by the plug pin 110.

The plug shield wall 140 may include first protrusions P1 that protrude from respective inner walls of the first longitudinal walls 141 and the first transverse walls 142. The first protrusions P1 are inserted into the first groove G1 of the plug body 120 to enhance the connection strength between the plug body 120 and the plug shield wall 140. By the first protrusions P1 contacting the first groove G1, the contact area between the plug shield wall 140 and the plug body 120 increases. In the vertical direction, the first protrusions P1 engage with the first groove G1, thereby increasing the connection strength between the plug body 120 and the plug shield wall 140.

The plug shield wall 140 may include a second protrusion P2 and a third protrusion P3. The second protrusion P2 and the third protrusion P3 protrude from the outer surface of the plug shield wall 140. The second protrusion P2 may protrude from the outer surface of the first longitudinal wall 141, and the third protrusion P3 may protrude from the outer surface of the first transverse wall 142. A plurality of second protrusions P2 and a plurality of third protrusions P3 may be arranged. In the vertical direction, the position of the second protrusion P2 may differ from that of the third protrusion P3. For example, the second protrusion P2 may be positioned adjacent to the lower end of the first longitudinal wall 141, and the third protrusion P3 may be positioned adjacent to the upper end of the first transverse wall 142.

These second protrusion P2 and third protrusion P3 are provided for coupling the plug shield wall 140 and the plug shell 130. The second protrusion P2 may be arranged in the second groove G2 of the plug shell 130, and the third protrusion P3 may be arranged in the third groove G3 of the plug shell 130.

The plug shield wall 140 is molded to form enclosed partitions S1 when viewed from the vertical direction.

The plug shield wall 140 may include a body BO made of a resin material and a coating layer CT applied to the surface of the body BO. The coating layer CT may be made of a metallic material. Since the body BO is molded, it is easy to implement a grid frame shape. Since the first longitudinal walls 141 and the first transverse walls 142 of the plug shield wall 140 are integrally formed of a resin material, it is possible to reduce weight, the absence of seams may prevent electromagnetic (EM) leakage, and the addition of a metal coating layer ensures that shielding performance is not compromised.

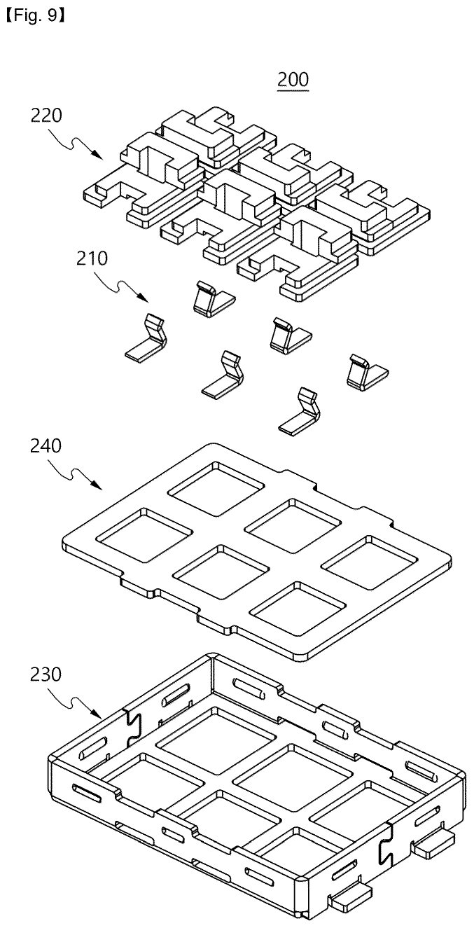

FIG. 9 is a view illustrating the RF receptacle connector 200.

Referring to FIG. 9, the RF receptacle connector 200 may include a receptacle pin 210, a receptacle body 220, a receptacle shell 230, and a receptacle shield wall 240.

The receptacle shield wall 240 is positioned inside the receptacle shell 230. The receptacle body 220 is positioned inside the receptacle shield wall 240. The receptacle body 220 forms a plurality of partitions S1, and a receptacle pin 210 is placed in each partition S1. For example, the plug body 120 may form six partitions S1, and six receptacle pins 210 may be placed, one in each partition S1.

The receptacle body 220 may be molded through double injection with the receptacle shield wall 240 and the receptacle pin 210 in place. Accordingly, in the molding process of the receptacle body 220, the receptacle shield wall 240 and the receptacle pin 210 may be formed to be coupled to the receptacle body 220.

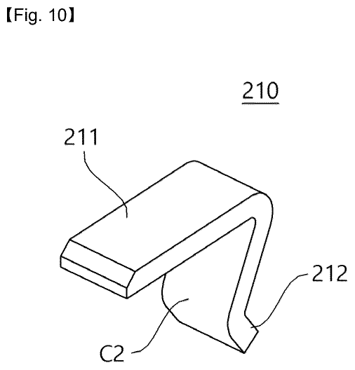

FIG. 10 is a view illustrating the receptacle pin 210.

Referring to FIG. 10, the receptacle pin 210 makes electrical contact with the plug pin 110. The receptacle pin 210 may be divided into a third part 211 and a fourth part 212. The third part 211 is a portion that is coupled to the receptacle body 220. The fourth part 212 may be bent from the third part 211 and include a second contact surface C2 that makes contact with the plug pin 110. The fourth part 212 may have a curved shape so that the second contact surface C2 can make contact with the first contact surface C1 of the plug pin 110. Since the fourth part 212 may deform in the X-axis direction due to the elastic force during the process of contacting the plug pin 110, it is preferable that a space not filled by the receptacle body 220 is formed around the fourth part 212.

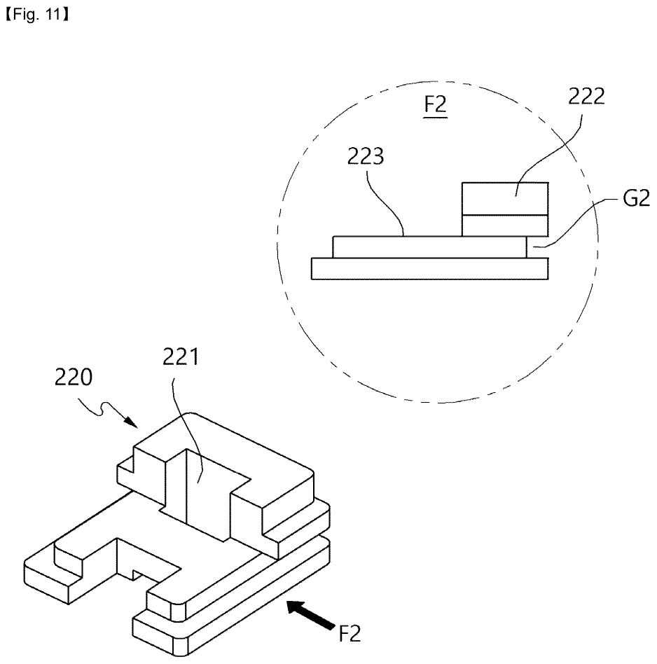

FIG. 11 is a view illustrating the receptacle body 220.

Referring to FIG. 11, the receptacle body 220 may have a first seating portion 121 on its upper surface, where the receptacle pin 210 is seated. Additionally, the receptacle body 220 may include a second groove G2 concavely formed on its side surface. The second groove G2 may be positioned along the periphery of the receptacle body 220. The second groove G2 is the part where the receptacle shield wall 240 is inserted.

Meanwhile, the receptacle body 220 may include a second convex portion 222 and a second concave portion 223.

The second convex portion 222 is a portion of the receptacle body 220 that protrudes relatively upwards, and the second concave portion 223 is a portion of the receptacle body 220 that is recessed relative to the second convex portion 222. The second convex portion 222 and the second concave portion 223 are for assembly with the plug body 120.

The plug body 120 or the receptacle body 220 has a reversed L shape (“7”) or an L shape (“L”), which is suitable for securing the plug pin 110 and the receptacle pin 210 to their respective bodies, forming a space around the fourth part 212 of the receptacle pin 210, and enhancing the connection strength between them.

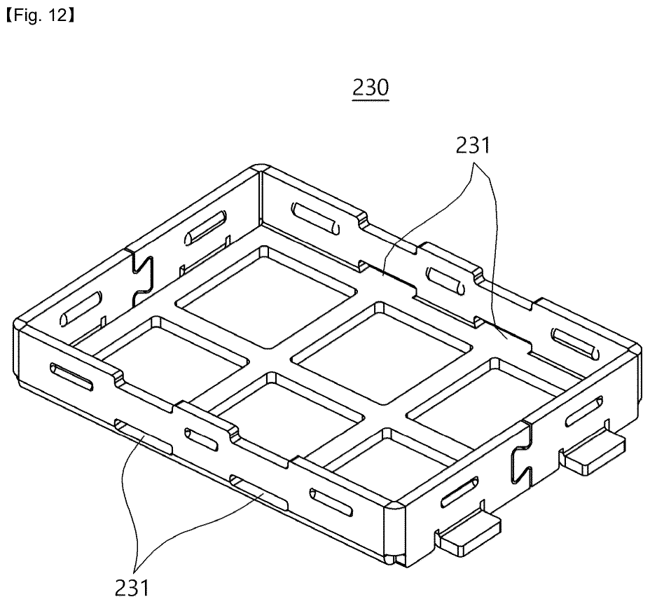

FIG. 12 is a perspective view of the receptacle shell 230.

Referring to FIG. 12, the receptacle shell 230 may be manufactured separately from the receptacle body 220, the receptacle pin 210, and the receptacle shield wall 240. The receptacle shell 230 forms a space inside to accommodate the RF plug connector 100. The RF plug connector 100 is accommodated within the receptacle shell 230.

The receptacle shell 230 may include a hole 231. The hole 231 is arranged on the lower surface of the longitudinal wall of the receptacle shell 230 and may be formed to connect the inside and outside of the receptacle shell 230. A plurality of holes 231 may be arranged. These holes 231 are provided for coupling with the receptacle shield wall 240.

The bottom of the receptacle shell 230 comes into contact with the receptacle shield wall 240, functioning as a shield wall. The bottom of the receptacle shell 230 may have a shape corresponding to the receptacle shield wall 240. For example, the bottom of the receptacle shell 230 may be arranged to form a grid in response to the receptacle shield wall 240, which is arranged to form a grid.

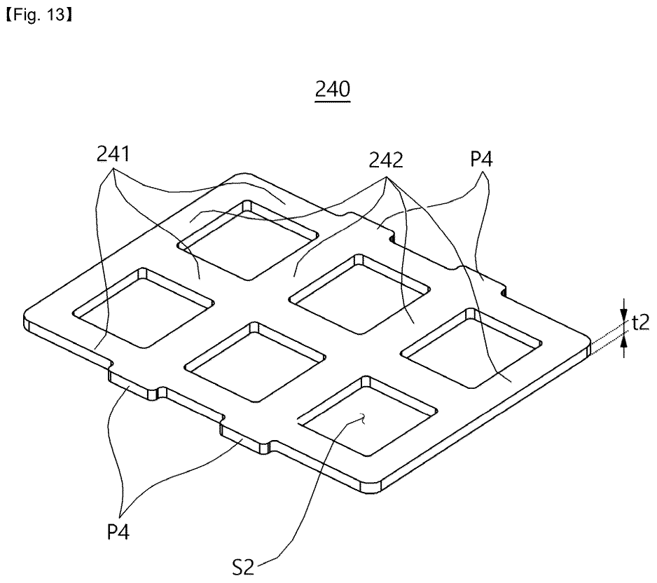

FIG. 13 is a view illustrating the receptacle shield wall 240.

Referring to FIG. 13, the receptacle shield wall 240 may include a plurality of second longitudinal walls 241 and a plurality of second transverse walls 242. The plurality of second longitudinal walls 241 may be arranged at regular intervals. The plurality of second longitudinal walls 241 may be arranged at regular intervals.

Each of the second longitudinal walls 241 is arranged to intersect with at least two of the second transverse walls 242. Likewise, each of the second transverse walls 242 is arranged to intersect with at least two of the second longitudinal walls 241. These second longitudinal walls 241 and second transverse walls 242 are arranged to form a grid structure, creating enclosed partitions S2 inside. The receptacle pin 210 is positioned in each partition S2. The second longitudinal walls 241 and second transverse walls 241 may have the same thickness. The upper ends of the second longitudinal walls 241 and the upper ends of the second transverse walls 241 may be positioned on the same plane.

The receptacle shield wall 240 forms the partitions S2, each of which surrounds a receptacle pin 210 inside, thereby shielding the EMI generated by the receptacle pins 210. Specifically, when viewed from the vertical direction, the second longitudinal walls 241 and the second transverse walls 242 are arranged to completely surround the receptacle pin 210, effectively shielding the EMI generated by the receptacle pin 210.

The receptacle shield wall 240 may include a plurality of fourth protrusions P4 protruding from its outer surface. The fourth protrusions P4 are inserted into the first groove G1 of the receptacle body 220 to enhance the connection strength between the receptacle body 220 and the receptacle shield wall 240.

The receptacle shield wall 240, like the plug shield wall 140, is molded to form enclosed partitions S1 when viewed from the vertical direction.

The receptacle shield wall 240 may be formed by punching a metal plate so that partitions S1 are created.

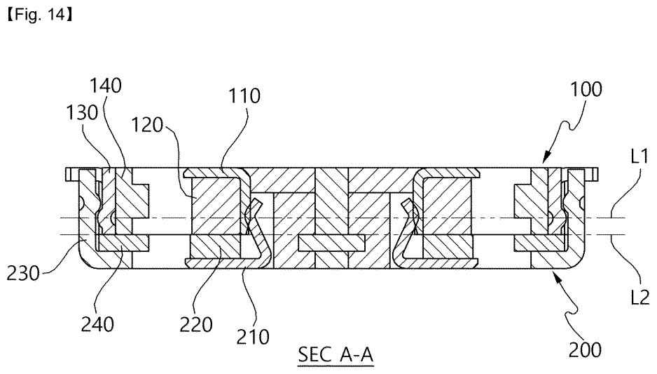

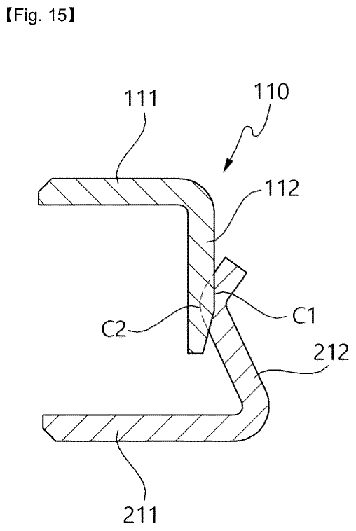

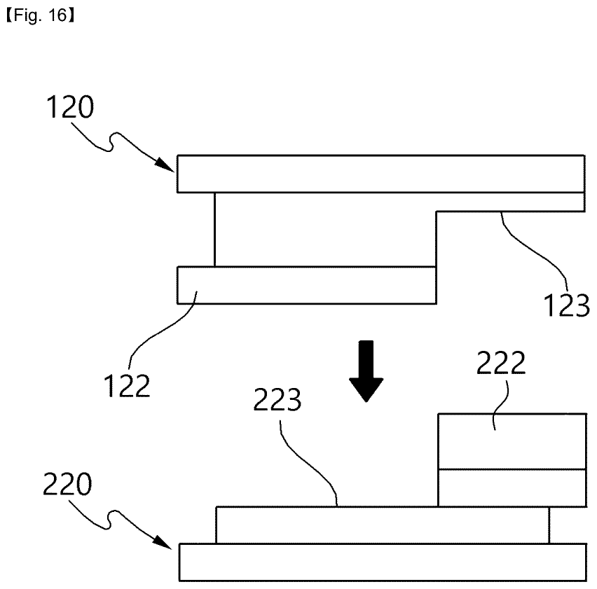

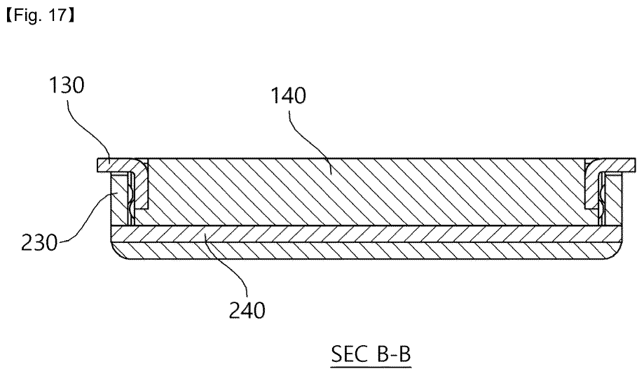

FIG. 14 is a cross-sectional side view of the RF connector, taken along line A-A of FIG. 1, FIG. 15 is a view illustrating the contact state of the plug pin 110 and the receptacle pin 210, FIG. 16 is a view illustrating the process of assembling the plug body 120 and the receptacle body 220, and FIG. 17 is a cross-sectional side view of the RF connector, taken along line B-B of FIG. 1.

Referring to FIGS. 14 to 17, when the RF plug connector is assembled into the RF receptacle connector 200, the partitions S1 of the RF receptacle connector 200 and the partitions S2 of the RF plug connector are aligned, forming a single independent partition (S1, S2). In addition, when the plug pin 110 and the receptacle pin 210 are aligned with each other, they make contact with each other in a contact area.

Once the RF plug connector is assembled into the RF receptacle connector 200, the plug body 120 and the receptacle body 220 are assembled within each independent partition (S1, S2). The first convex portion 122 of the plug body 120 is assembled into the second concave portion 223 of the receptacle body 220, and the second convex portion 222 of the receptacle body 220 is assembled into the first concave portion 123 of the plug body 120.

In this way, in the process of assembling the plug body 120 and the receptacle body 220, the first contact surface C1 of the plug pin 110 and the second contact surface C2 of the receptacle pin 210 come into contact within each independent partition (S1, S2), so that the RF plug connector is electrically connected to the RF receptacle connector 200.

The plug pin 110 and the receptacle pin 210 are positioned inside the independent partition S1. The independent partition S1 is surrounded by the plug shield wall 140 and the receptacle shield wall 240, preventing the EMI inside the independent partition S1 from being emitted to the outside of the partition S1. In other words, the EMI in each partition S1 can be separately shielded.

The thickness t1 of the plug shield wall 140 may be relatively greater than the thickness t2 of the receptacle shield wall 240.

L1 in FIG. 14 is a reference line indicating the contact area between the plug pin 110 and the receptacle pin 210, and L2 in FIG. 14 is a reference line indicating the contact area where the lower end of the plug shield wall 140 and the upper end of the receptacle shield wall 240 meet.

The reference line L2, which indicates the contact area where the lower end of the plug shield wall 140 and the upper end of the receptacle shield wall 240 meet, is positioned lower than the reference line L1, which indicates the contact area between the plug pin 110 and the receptacle pin 210.

The thickness t1 (shown in FIG. 7) of the plug shield wall 140 may be implemented to be thick enough to cover the contact area between the plug pin 110 and the receptacle pin 210. This is because the vertical positions of the contact area between the plug pin 110 and the receptacle pin 210 and the contact area where the lower end of the plug shield wall 140 and the upper end of the receptacle shield wall 240 meet are different, so that it is possible to prevent EMI from leaking through the contact point where the plug shield wall 140 and the receptacle shield wall 240 meet.

Meanwhile, the receptacle shell 230 may be positioned to cover the contact area where the lower end of the plug shield wall 140 and the upper end of the receptacle shield wall 240 meet. This receptacle shield wall 240 may prevent EMI from leaking through the gap between the lower end of the plug shield wall 140 and the upper end of the receptacle shield wall 240.

Additionally, the plug body 120 and receptacle body 220 are arranged such that the receptacle shell 230 covers the contact area where the lower end of the plug shield wall 140 and the upper end of the receptacle shield wall 240 meet, preventing EMI from leaking through the gap between the lower end of the plug shield wall 140 and the upper end of the receptacle shield wall 240.

As described above, although exemplary embodiments of the present invention have been described, various embodiments disclosed in “Detailed Description” are provided only for the illustrative purpose. Those skilled in the art can understand that various modifications, variations, and equivalents of the present invention are possible based on the above description.

In addition, since the present invention can be realized in various forms, the present invention is not limited to the above embodiments. The above description is provided only to allow those skilled in the art to perfectly understand the scope of the present invention, and those skilled in the art should know that the present invention is defined by the appended claims.

What is claimed is:

1. A radio frequency (RF) plug connector in which a plurality of plug partitions are arranged in rows and columns, the RF plug connector comprising:
a plug shield wall configured to form the plug partitions in a grid shape;
a plug body arranged within the plug partition;
a plug pin coupled to the plug body; and
a plug shell coupled to the plug shield wall,
wherein the plug shield wall comprises a plurality of first longitudinal walls arranged with the plug pin positioned therebetween, and a plurality of first transverse walls intersecting with the first longitudinal walls, with the plug pin positioned therebetween.

2. The RF plug connector of claim 1, wherein one of the first longitudinal walls is arranged to intersect with at least two of the first transverse walls, and one of the first transverse walls is arranged to intersect with at least two of the first longitudinal walls.

3. The RF plug connector of claim 1, wherein two of the first longitudinal walls are arranged opposite each other with the plug pin positioned therebetween,
two of the first transverse walls are arranged opposite each other with the plug pin positioned therebetween, and
the first longitudinal walls and the first transverse walls are connected to each other to surround the plug pin.

4. The RF plug connector of claim 1, wherein the plug shield wall comprises first protrusions protruding from respective inner walls of the first longitudinal walls and the first horizontal walls,
the plug body comprises a first groove concavely formed on a side surface thereof, and
the first protrusion is arranged in the first groove.

5. The RF plug connector of claim 4, wherein the plug shield wall comprises a second protrusion and a third protrusion protruding from an outer surface thereof, and the plug shell comprises a second groove in which the second protrusion is placed and a third groove in which the third protrusion is placed.

6. The RF plug connector of claim 5, wherein in a vertical direction, a position of the first protrusion differs from a position of the second protrusion,
the second groove is concavely formed on an upper end of the plug shell, and
the third groove is concavely formed on a lower end of the plug shell.

7. The RF plug connector of claim 1, wherein the plug shield wall comprises a body made of a resin material, and a metal layer coated on the body.

8. The RF plug connector of claim 1, wherein the plug pin comprises a first part coupled to the plug body, and a second part that is bent from the first part and include a first contact surface, and the first contact surface is formed as a flat surface.

9. A radio frequency (RF) receptacle connector in which a plurality of receptacle partitions are arranged in rows and columns, the RF receptacle connector comprising:
a receptacle shield wall configured to form the receptacle partitions in a grid shape;
a receptacle body arranged within the receptacle partition;
a receptacle pin coupled to the receptacle body; and
a receptacle shell coupled to the receptacle shielding wall,
wherein the receptacle shield wall comprises a plurality of second longitudinal walls arranged with the plug pin positioned therebetween, and a plurality of second transverse walls intersecting with the second longitudinal walls, with the plug pin positioned therebetween.

10. The RF receptacle connector of claim 9, wherein one of the second longitudinal walls is arranged to intersect with at least two of the second transverse walls, and one of the second transverse walls is arranged to intersect with at least two of the second longitudinal walls.

11. The RF receptacle connector of claim 9, wherein two of the second longitudinal walls are arranged opposite each other with the receptacle pin positioned therebetween,
two of the second transverse walls are arranged opposite each other with the receptacle pin positioned therebetween, and
the second longitudinal walls and the second transverse walls are connected to each other to surround the receptacle pin.

12. The RF receptacle connector of claim 9, wherein the receptacle body comprises a second groove concavely formed on a side surface thereof, and a portion of the receptacle body is arranged in the second groove.

13. The RF receptacle connector of claim 9, wherein the receptacle shield wall comprises a fourth protrusion protruding from an outer surface thereof, and the receptacle shell comprises a hole in which the fourth protrusion is arranged.

14. The RF receptacle connector of claim 13, wherein the hole is arranged on a lower end of the receptacle shell and passes through an inside and outside of the receptacle shell.

15. The RF receptacle connector of claim 9, wherein the receptacle shield wall is made of a metallic material.

16. The RF receptacle connector of claim 9, wherein the receptacle pin comprises a third part coupled to the receptacle body, and a fourth part that is bent from the third part and includes a second contact surface, and the second contact surface is formed as a curved surface.

17. A radio frequency (RF) connector comprising:
an RF plug connector in which a plurality of plug partitions are arranged in rows and columns; and
an RF receptacle connector in which a plurality of receptacle partitions are arranged in rows and columns,
wherein the RF plug connector comprises a plug shield wall configured to form a grid surrounding a plug pin,
the RF receptacle connector comprises a receptacle shield wall configured to form a grid surrounding a receptacle pin, and
the plug shielding wall is stacked on the receptacle shield wall.

18. The RF connector of claim 17, wherein the plug shield wall comprises a plurality of first longitudinal walls arranged with the plug pin positioned therebetween and a plurality of first transverse walls intersecting with the first longitudinal walls, with the plug pin positioned therebetween, and
the receptacle shield wall comprises a plurality of second longitudinal walls arranged with the plug pin positioned therebetween, and a plurality of second transverse walls intersecting with the second longitudinal walls, with the plug pin positioned therebetween.

19. The RF connector of claim 18, wherein in a vertical direction, a thickness of the plug shield wall is greater than a thickness of the receptacle shield wall.

20. The RF connector of claim 18, wherein a lower surface of the plug shield wall is in contact with an upper surface of the receptacle shield wall.

21. The RF connector of claim 18, wherein a contact area between the plug shield wall and the receptacle shield wall is positioned lower than a contact area between the plug pin and the receptacle pin in a vertical direction.
